(19) United States
(12) Patent Application Publication
(10) Pub. No.: US 2025/0335459 A1
(43) Pub. Date: Oct. 30, 2025

(54) EXTERNAL DATA SOURCE DATA ORCHESTRATION

(71) Applicant: Capital One Services, LLC, McLean, VA (US)

(72) Inventors: Raja CHATTOPADHYAY, Glen Allen, VA (US); Santhosh Kumar KUPPURAJ, Glen Allen, VA (US); Thiagarajan SUBRAMANIAN, Glen Allen, VA (US); Ravi GUDURU, Henrico, VA (US); Sunil CHOUDHARY, Boonton, NJ (US)

(21) Appl. No.: 18/649,446

(22) Filed: Apr. 29, 2024

(51) Int. Cl. G06F 21/62; G06F 16/25; G06F 40/284

(52) U.S. Cl. CPC G06F 40/284; G06F 16/256

(57) ABSTRACT

In some implementations, a device may receive, from a client device, a first request for data that is accessible via an external data source of one or more external data sources, wherein the device includes one or more integration service components associated with respective external data sources of the one or more external data sources. The device may provide, to an integration service component of the one or more integration service components, the first request. The device may provide, to the external data source, a second request via the integration service component, wherein the second request is based on the first request. The device may receive, from the external data source, a response that includes the data indicated by the first request via the integration service component. The device may provide, to the client device, the data requested by the first request based on receiving the response.

### BACKGROUND

Data orchestration is the process of gathering siloed data from various locations, organizing the data into a consistent, usable format, and activating the data for use by one or more data analysis tools. Data orchestration enables entities to take various fragmented data pipelines and turn the data pipelines into valuable data sources that enable improved decision-making. For example, data orchestration may include the coordination and management of multiple computer systems, applications, and/or services, and stringing together multiple tasks in order to execute a larger workflow or process.

### SUMMARY

In some implementations, a system for external data source data orchestration includes a gateway; an integration service layer including one or more integration service components for respective external data sources of one or more external data sources; and an orchestration component configured to: receive, via a client device, a first request for data that is accessible via an external data source of the one or more external data sources; provide, to an integration service component of the one or more integration service components, the first request, wherein the integration service component is configured to generate requests for data from the external data source; generate, based on providing the first request to the integration service component, a second request via the integration service component; provide, by the integration service component and via the gateway, the second request to the external data source; receive, by the integration service component and via the gateway, a response from the external data source that includes the data indicated by the first request; and provide, to the client device, the data requested by the first request based on receiving the response.

In some implementations, a method for external data source data orchestration comprising: receiving, by a device and from a client device, a first request for data that is accessible via an external data source of one or more external data sources, wherein the device includes one or more integration service components associated with respective external data sources of the one or more external data sources; providing, by the device and to an integration service component of the one or more integration service components, the first request; providing, by the device and to the external data source, a second request via the integration service component, wherein the second request is based on the first request; receiving, by the device and from the external data source, a response that includes the data indicated by the first request, wherein the response is received via the integration service component; and providing, by the device and to the client device, the data requested by the first request based on receiving the response.

In some implementations, a non-transitory computer-readable medium storing a set of instructions includes one or more instructions that, when executed by one or more processors of a device, cause the device to: receive, from a client device, a first request for data that is accessible via an external data source of one or more external data sources, wherein the device includes one or more integration service components associated with respective external data sources of the one or more external data sources; provide, to an integration service component of the one or more integration service components, the first request; provide, to the external data source, a second request via the integration service component, wherein the second request is based on the first request; receive, from the external data source, a response that includes the data indicated by the first request, wherein the response is received via the integration service component; and provide, to the client device, the data requested by the first request based on receiving the response.

### BRIEF DESCRIPTION OF THE DRAWINGS

FIGS. 1A-1C are diagrams of an example associated with external data source data orchestration, in accordance with some embodiments of the present disclosure.

FIG. 2 is a diagram of an example data orchestration system associated with external data source data orchestration, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with external data source data orchestration, in accordance with some embodiments of the present disclosure.

FIG. 5 is a flowchart of an example process associated with external data source data orchestration, in accordance with some embodiments of the present disclosure.

### DETAILED DESCRIPTION

The following detailed description of example implementations refers to the accompanying drawings. The same reference numbers in different drawings may identify the same or similar elements.

“Data orchestration” may refer to the process of managing and coordinating the flow of data across various systems, applications, and/or environments, such as within an organization or an entity. For example, an orchestration device may use one or more data pipelines to facilitate the movement and transformation of data from a source to a destination. A data pipeline may use one or more data transfer techniques, such as extract, transform, and load (ETL) tools, messaging queues, and/or data integration platforms, among other examples, to enable data movement and processing.

In some examples, a data source may be an external data source. “External data source” may refer to a data source that is managed, stored, and/or otherwise controlled outside of an entity or organization associated with the orchestration device. For example, an orchestration device may collect data from one or more external data sources for use across one or more systems, applications, and/or environments (e.g., within the entity or organization associated with the orchestration device). However, performing data orchestration in association with multiple external data sources may be complex and consume significant processing resources, network resources, and/or memory resources, among other examples. For example, each external data source may have an independent or different data format, schema, and/or access protocols, among other examples. Integrating data from disparate external data sources may be associated with this heterogeneity, which may include complex data transformation processes to ensure consistency and compatibility across all external data sources.

As another example, accessing and integrating data from multiple external sources may present data security and/or privacy issues. For example, different external data systems may have different access control mechanisms and/or different authorized users who are permitted to access data from a given external data source. Therefore, integrating data from external sources may result in a user and/or application accessing data from an external data source for which the user and/or application is authorized. Additionally, access control may be different for different external data sources, increasing the complexity associated with implementing access policies based on user roles, privileges, and/or data sensitivity levels, among other examples, for different external data sources. Further, some external data sources may include sensitive data that is to be masked or obfuscated before being shared with an application or user. However, it may be difficult to implement consistent data masking and/or anatomization across multiple external data sources because of the heterogenous data formats and/or schemas for the different external data sources, thereby increasing the risk of sensitive data being shared with an unauthorized application or user.

In some examples, because of the challenges associated with reliably integrating an external data source for use by the orchestration device, separate pipelines may be designed, configured, and/or implemented for respective external data sources to ensure that data from each external data source is properly integrated and/or shared by the orchestration device. However, this may consume significant processing resources, network resources, and/or memory resources, among other examples, because each pipeline may be associated with dedicated processing resources, network resources, and/or memory resources. This problem may be compounded as more external data sources are integrated into a data orchestration system, limiting the scalability of the data orchestration system. Further, the use of separate pipelines for respective external data sources may consume processing resources, network resources, and/or memory resources, among other examples, associated with updating or making changes for the data orchestration system because the updates or changes may need to be made to each pipeline separately. Additionally, the use of separate pipelines for respective external data sources may increase onboarding time associated with adding a new external data source for use by the data orchestration system because a new pipeline may need to be built, configured, and/or implemented for the new external data source, thereby consuming time and resources (e.g., processing resources, computing resources, and/or network resources) associated with establishing and/or implementing the new pipeline before the data orchestration system can access data from the new external data source.

Some implementations described herein enable enhanced external data source data orchestration. For example, an orchestration system may include an integration service layer including one or more integration service components for respective external data sources. An integration service component may be configured to generate requests for data from a given external data source and/or receive data from the given external data source. For example, an integration service component may be configured to communicate with a given external data source in accordance with a format, schema, access protocol, and/or other mechanisms that may be specific to the given external data source. For example, an orchestration device may be enabled to access an external data source via a configured integration service component for the external data source.

For example, the orchestration device may receive, via a client device, a first request for data that is accessible via an external data source. The orchestration device may provide, to an integration service component of one or more integration service components included in the integration service layer, the first request. For example, the orchestration device may identify or determine the integration service component that is configured to access and/or communicate with the external data source. The orchestration device may generate, based on providing the first request to the integration service component, a second request via the integration service component. For example, the integration service component may format and/or configure the second request in a format that is used by the external data source. The orchestration device may provide, via the integration service component and via a gateway, the second request to the external data source. The orchestration device may receive, by the integration service component and via the gateway, a response from the external data source that includes the data indicated by the first request. For example, the integration service component may receive the response and extract the data indicated by the first request based on a format, configuration, and/or schema used by the external data source. The orchestration device may provide, to the client device, the data requested by the first request based on receiving the response from the external data source via the integration service component.

In some implementations, the data orchestration system may include one or more components (e.g., the integration service component or another component) configured to decrypt and/or encrypt sensitive information in requests. For example, the first request (e.g., from the client device) may include tokenized information. The integration service component may be configured to decrypt the tokenized information to obtain request information (e.g., where the request information may include sensitive information). The second request (e.g., that is transmitted to the external data source) may include the request information. Additionally, or alternatively, the response from the external data source may include sensitive information. The integration service component may be configured to encrypt the sensitive information to generate tokenized information to obfuscate the sensitive information. The data that is provided to the orchestration device and/or the client device may include the tokenized information.

As a result, by using an integration service layer and/or integration service components for respective external data sources, the data orchestration system described herein may conserve processing resources, network resources, and/or memory resources, among other examples, that would have otherwise been associated with the use of separate pipelines for each external data source. For example, the orchestration device may use one or more components (e.g., processing components, computing components, and/or memory components) for operations associated with multiple external data sources (e.g., rather than having to configure and/or implement separate components for each external data source). By enabling the orchestration device to access data from an external data source based on the configuration of an integration service component in the integration service layer, the data orchestration system may conserve time, processing resources, network resources, and/or memory resources, among other examples, that would have otherwise been associated with building and/or configuring pipelines for each external data source, maintaining separate pipelines for each external data source, and/or integrating a change or update across each of the separate pipelines, among other examples. For example, integrating a new external data source into the data orchestration system may include configuring a new integration service component, which may conserve time and/or resources as compared to building and/or integrating a full pipeline for the new external data source (e.g., which may include a dedicated orchestration device, memory resources, processing resources, networking resources, and/or other dedicated components).

The orchestration system may enable the configurations, formats, access protocols, and/or schemas of external communications to the external data sources to be abstracted from internal data requests and/or responses associated with data from the external data sources. Additionally, because the integration service components may be configured to provide data to the orchestration device in a uniform and/or predictable manner, the data orchestration system may generate more accurate and/or insightful reports and/or log data for communications associated with accessing data from the external data sources.

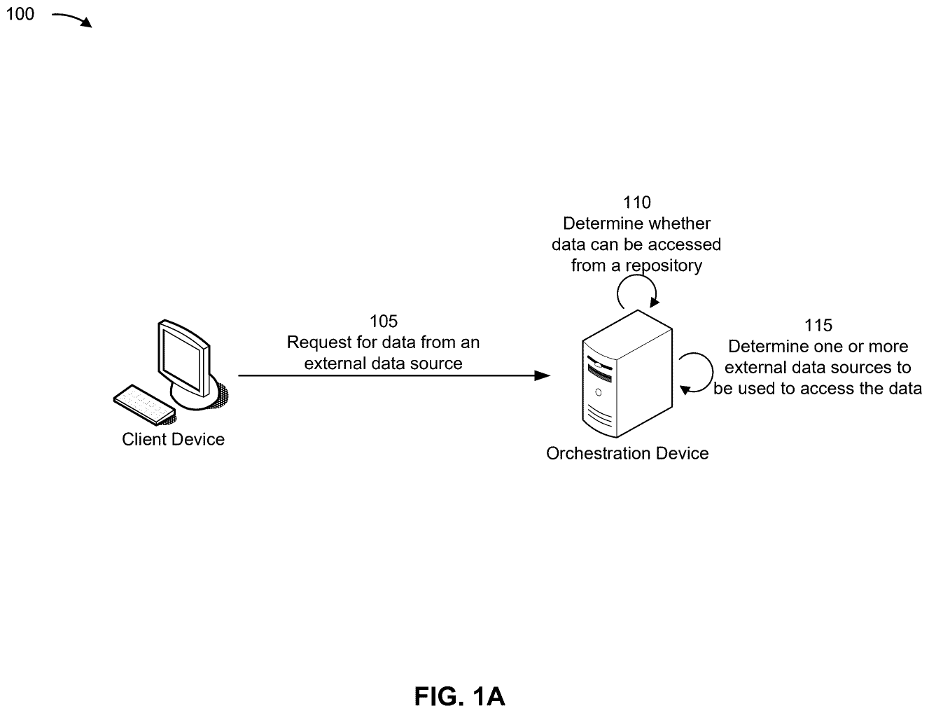

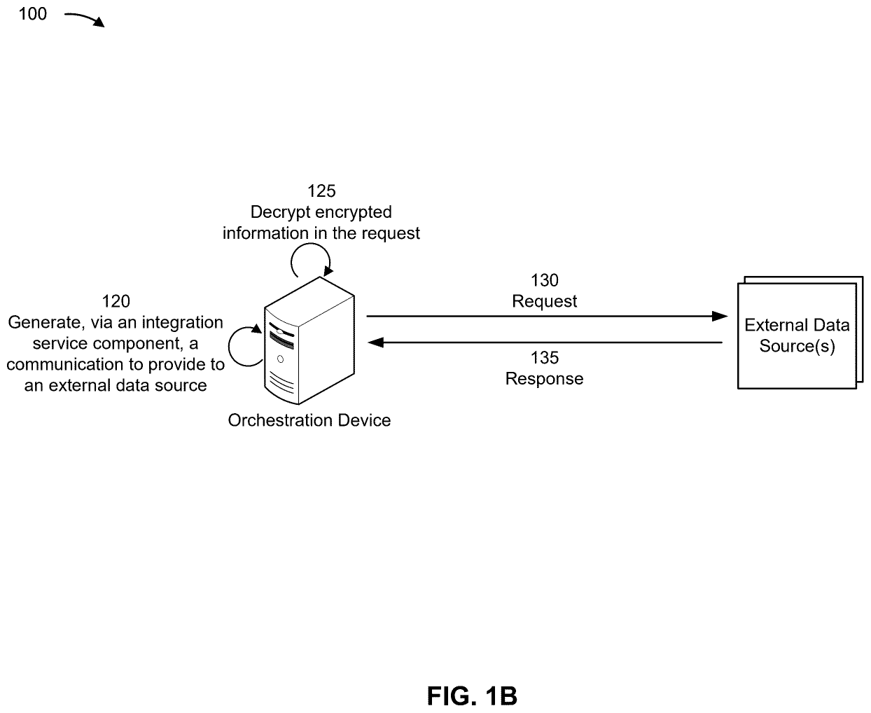

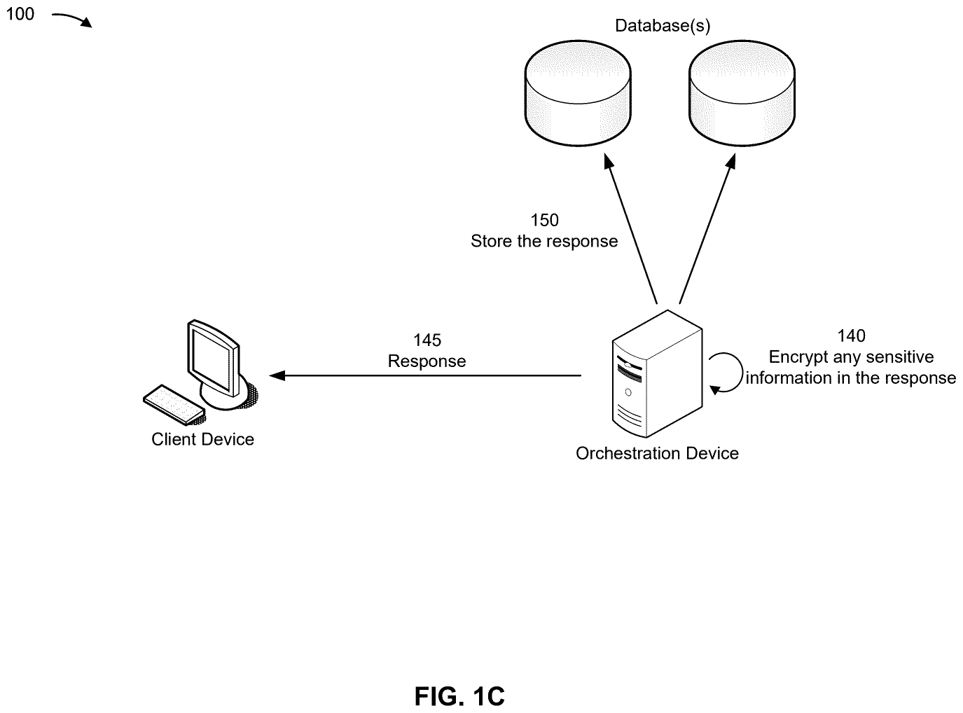

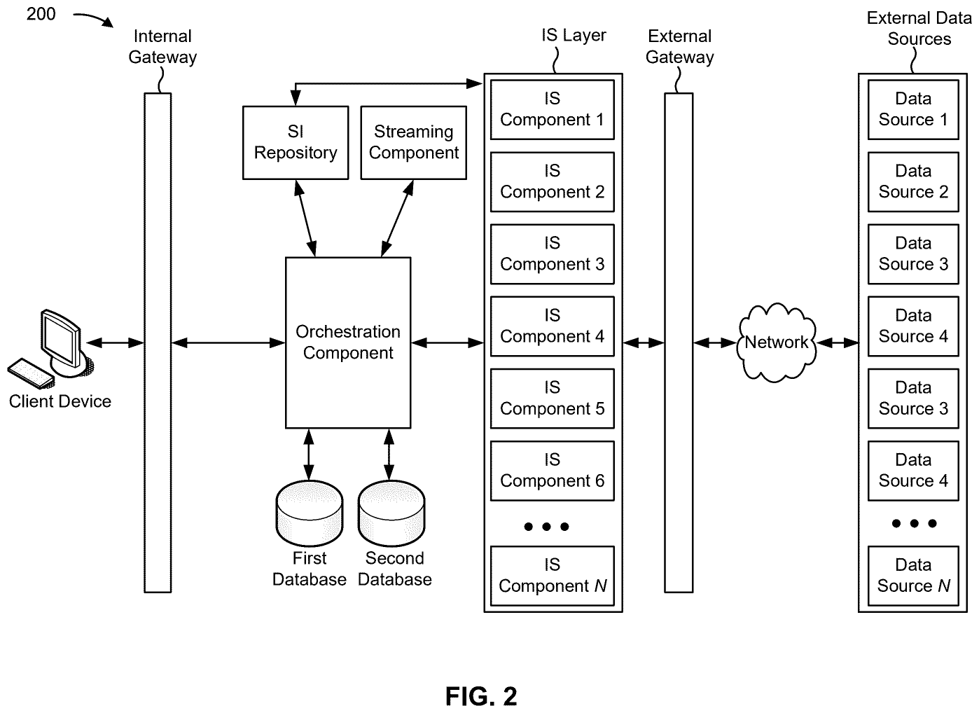

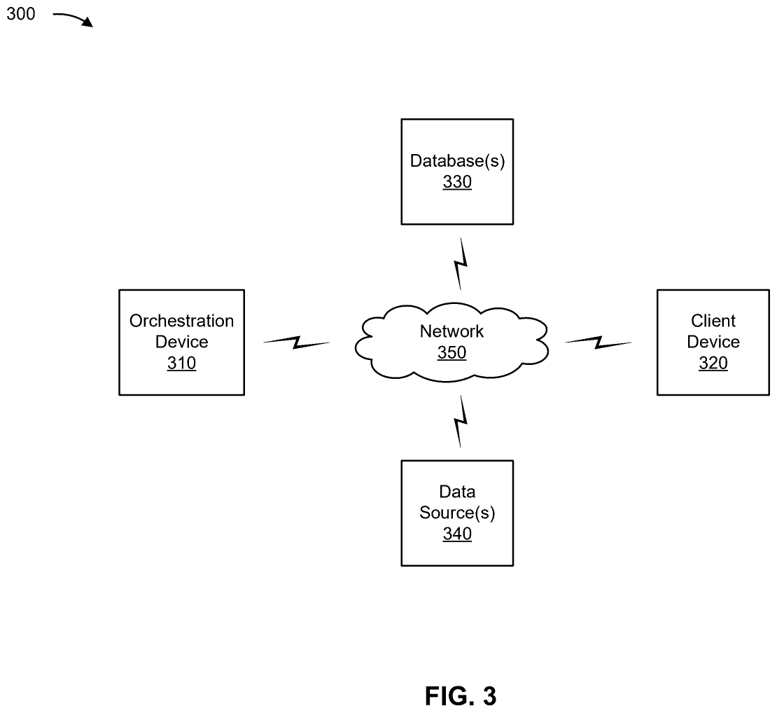

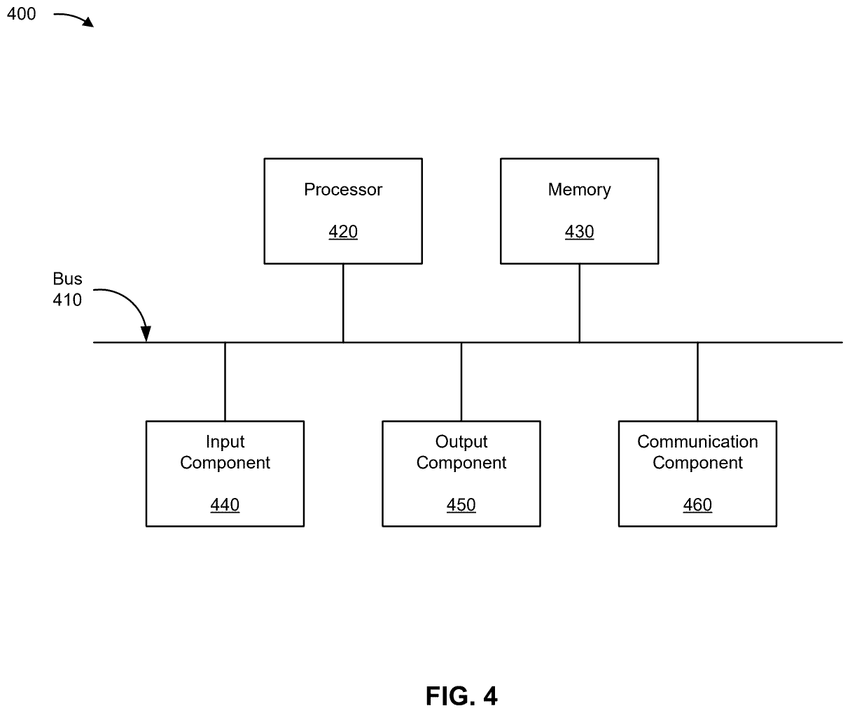

FIGS. 1A-1C are diagrams of an example 100 associated with external data source data orchestration. As shown in FIGS. 1A-1C, example 100 includes a client device, an orchestration device, one or more external data sources, and one or more databases. These devices are described in more detail in connection with FIGS. 3 and 4. The orchestration device and the one or more databases may be included in a data orchestration system, such as the data orchestration system depicted and described in more detail in connection with FIG. 2.

As shown in FIG. 1A, and by reference number 105, the client device may transmit, and the orchestration device may receive, a request for data from an external data source. For example, the orchestration device may receive, from the client device, request for data that is accessible via one or more external data sources. For example, the data may be stored by the one or more external data sources.

The client device may transmit the request via an application programming interface (API) call or via another type of communication. For example, the orchestration device may make a communication channel available for use by the client device to enable the client device to request data from external data sources. As an example, the orchestration device may transmit, and the client device may receive, configuration information that indicates API endpoints and/or other information to enable the client device to transmit the request to the orchestration device. In some examples, the client device may transmit the request via a gateway (e.g., a gateway that is internal to the orchestration device and/or the data orchestration system).

The orchestration device may perform one or more operations to validate the request. For example, the orchestration device may determine whether the client device (and/or a user or application that caused the request to be transmitted via the client device) is authorized to access the data indicated by the request. The orchestration device may validate the request to ensure that the request meets one or more criteria and/or to validate that the client device is authorized to access the requested data. For example, the orchestration device may verify the authenticity and/or integrity of the request by checking one or more credentials or tokens provided by or via the request. For example, the orchestration device may validate one or more API keys, tokens, and/or other forms of authentication tokens using a list of authorized users or clients (e.g., for a type of data that is requested). Additionally, or alternatively, the orchestration device may check one or more parameters and/or attributes of the request to ensure that the one or more parameters and/or attributes adhere to expected formats and/or constraints. For example, the orchestration device may validate a request method, a structure, one or more query parameters, a header, and/or payload data included in the request using one or more expected or defined schemas or patterns. If the orchestration device validates and/or authenticates the request, then the orchestration device may obtain the data from an external data source, as described in more detail elsewhere herein. If the orchestration device determines that the request is not validated and/or authenticated, then the orchestration device may reject the request and refrain from obtaining the data indicated by the request.

In some implementations, as shown by reference number 110, the orchestration device may determine whether the data (e.g., indicated by the request) can be accessed from a repository, such as the one or more databases. For example, the orchestration device may perform a lookup operation in one or more repositories, databases, and/or caches to determine whether the data is stored locally and/or in a storage location that can be accessed by the orchestration device without communicating with an external data source.

If the orchestration device determines that the data is stored in a repository (e.g., a local repository), then the orchestration device may determine whether an amount of time that the data has been stored in the repository satisfies a time threshold. If the amount of time satisfies the time threshold, then the orchestration device may obtain the data from the repository and transmit the data to the client device (e.g., without communicating with an external data source). If the amount of time that the data has been stored in the repository does not satisfy the time threshold and/or if the data is not stored in one or more repositories, databases, and/or caches, then the orchestration device may obtain the data from an external data source, as described in more detail elsewhere herein. By the orchestration device determining whether the data (e.g., indicated by the request) can be accessed from a repository, the orchestration device may conserve time, processing resources, computing resources, and/or network resources, among other examples, that would have otherwise been associated with obtaining the data from an external data source when the data could have been obtained from a repository or database (e.g., without communicating with the external data source).

As shown by reference number 115, the orchestration device may determine one or more external data sources to be used to access the data. For example, the orchestration device may identify a type or category associated with the data indicated by the request. The orchestration device may determine the one or more external data sources based on the type or category associated with the data. For example, the one or more external data sources may be data sources that store the type or category of data. Additionally, or alternatively, the request may include an indication of the one or more external data sources. The orchestration device may determine the one or more external data sources based on the indication included in the request.

In some examples, the data may be accessible via multiple external data sources. In such examples, the orchestration device may determine that the data is to be retrieved via a given external data source based on one or more performance parameters associated with the respective external data sources of the multiple external data sources. The performance parameters may include a latency parameter, a cost parameter (e.g., a monetary cost associated with accessing data from a given data source), a throughput parameter (e.g., a rate at which data can be transferred or processed in a given time period), a resource utilization parameter (e.g., for a utilization of resources, such as processing resources (e.g., central processing unit (CPU) resources), memory resources, disk resources, and/or network bandwidth resources), an availability parameter (e.g., indicating a percentage of time that a given external data source is accessible and/or operational), and/or a reliability parameter (e.g., indicating an accuracy level of completed requests by a given external data source), among other examples. For example, the one or more performance parameters may indicate a relative performance level of a given external data source for providing requested data.

The orchestration device may determine that the data is to be retrieved via a given external data source based on the given external data source having the best values (e.g., highest value or lowest value, depending on the context and/or the performance parameter) for the one or more performance parameters among the multiple external data sources via which the data (e.g., indicated by the request) can be accessed. This enables the orchestration device to access and/or obtain the requested data with improved performance and/or reduced costs, among other examples.

As shown in FIG. 1B, and by reference number 120, the orchestration device may generate, via an integration service component, a communication to provide to an external data source (e.g., the external data source via which the requested data is to be obtained). The communication may be a request for the data from the external data source. The integration service component may be a component of the data orchestration system. For example, the integration service component may be included in an integration service layer of the data orchestration system.

For example, integration service components may be configured to communicate with an external data source and one or more other components included in the data orchestration system, such as an orchestration component. An integration service component may obtain configuration information to enable the integration service component to exchange information with an external data source. The configuration information may also be referred to herein as a protocol configuration. The configuration information may indicate one or more communication formats, schema, access protocols, security information, and/or other information to enable the integration service component to generate and/or communicate one or more communications with the external data source. For example, an integration service component may be configured to generate communications using protocols (e.g., a format, syntax, platform, set of rules, or other information) for a given external data source. The configuration-based approach enables new data sources to be quickly integrated into the data orchestration system with an efficient usage of resources.

For example, the orchestration device may identify an integration service component associated with the external data source (e.g., that is determined by the orchestration device as described in more detail elsewhere herein, such as in connection with FIG. 1A). For example, the orchestration device may store a list or mapping indicating which integration service components are associated with which external data sources. The orchestration device may provide, to the integration service component, the request for the data (e.g., the request obtained via the client device, which may be referred to herein as a first request or a client request).

The orchestration device may generate, based on providing the request (e.g., the client device) to the integration service component, another request (e.g., which may be referred to herein as a second request or an external request) via the integration service component. For example, an external request may be a request that is transmitted to an external data source. For example, the integration service component may generate a payload of the external request using the client request and a protocol configuration associated with the external data source. The integration service component may store the protocol configuration and use the protocol configuration to format the payload in a manner that is expected and/or that can be decoded by the external data source.

As shown by reference number 125, the orchestration device may decrypt encrypted information in the client request as part of generating the external request. For example, the client request may include tokenized information. The tokenized information may be encrypted information. For example, the tokenized information may be obfuscated sensitive information. “Sensitive information” may refer to information that is confidential, secret, personal, and/or otherwise protected. Unauthorized disclosures and/or storing of sensitive information may result in legal liability and/or financial liability for the entity associated with the orchestration device. As an example, sensitive information may be information that is subject to one or more regulatory requirements to maintain the secrecy or confidentiality of the information (e.g., antitrust regulations or other regulations promulgated by a regulatory agency). In some implementations, the sensitive information may be sensitive business information. For example, the platform may collect and/or provide information associated with one or more entities, vendors, or companies, and the sensitive information may include competitively sensitive information provided by the one or more entities, vendors, or companies. As another example, sensitive information may include personally identifiable information of an individual, such as a social security number, a name, an address, and/or income information, among other examples.

The integration service component (and/or another component of the data orchestration system) may decrypt the tokenized information to obtain sensitive information. For example, the integration service component may decrypt the tokenized information using a token vault or a tokenization system. The token vault may include a secure storage location in which sensitive information (e.g., that has been encrypted or tokenized) is stored. The integration service component may provide, to the token vault, a request to access original data (e.g., sensitive information) associated with a token. For example, the integration service component may provide, and the token vault may receive, a decryption request. The token vault may decrypt the tokenized information (e.g., using a decryption key or algorithm) to obtain the sensitive information. The token vault may provide, and the integration service component may receive, the sensitive information. The integration service component may include the sensitive information in the external request (e.g., to enable the external data source to obtain data based on, or using, the sensitive information).

As shown by reference number 130, the orchestration device may transmit, and the external data source may receive, a request for data. For example, the request may be the external request that requests data indicated by the client request. In some implementations, the integration service component (e.g., that is associated with the external data source) may transmit the external request. The external request may be transmitted via an API, a platform, and/or another communication channel associated with the external data source. The external request may be packaged and/or formatted (e.g., by the integration service component) in a manner that can be understood, decoded, and/or otherwise read by the external data source.

The external data source may extract information from the request, such as sensitive information, an indication of requested data, and/or other information to enable the external data source to obtain the requested data. The external data source may validate and/or authenticate the external request (e.g., in a similar manner as described elsewhere herein). The external data source may obtain the requested data. For example, the external data source may perform a lookup operation using information included in the request to obtain the requested data.

As shown by reference number 135, the external data source may transmit, and the orchestration device may receive, a response. The response may include the requested data. In some implementations, the external data source may transmit the response to the integration service component. The integration service component may extract information from the response, such as the requested data. For example, the integration service component may use configuration information (e.g., the protocol configuration) to enable the integration service component to identify and/or extract relevant data (e.g., the requested data) from the response received from the external data source.

As shown in FIG. 1C, and by reference number 140, the orchestration device may encrypt any sensitive information in the response. For example, the response may include sensitive information (e.g., the requested data may include sensitive information). The orchestration device may encrypt the sensitive information to obfuscate the sensitive information. In some implementations, the integration service component may be configured to encrypt the sensitive information to generate tokenized information to obfuscate the sensitive information. For example, the integration service component may transmit, and the token vault may receive, an encryption request to tokenize the sensitive information. The token vault may encrypt the sensitive information by replacing the sensitive information with one or more tokens (e.g., using an encryption or tokenization technique or algorithm). The token vault may store the sensitive information (e.g., in a secure storage location). The token vault may transmit, and the integration service component may receive, the tokenized information.

As shown by reference number 145, the orchestration device may transmit, and the client device may receive, a response. The response may include data (e.g., the requested data) indicated by the client request (e.g., transmitted by the client device as described in connection with FIG. 1A and reference number 105). In some examples, the response transmitted to the client device may include tokenized information (e.g., obfuscated sensitive information).

The orchestration device may perform one or more actions based on receiving the response from the external data source. For example, the orchestration device may provide, via a streaming platform, the data to a data lake based on receiving the response. The data lake may be a centralized repository for the entity associated with the orchestration device. The data lake may be a storage location for structured, semi-structured, and/or unstructured data associated with the entity. For example, the data lake may include raw, unprocessed data in a native format (e.g., the format in which the requested data is provided by the external data source). This may enable other applications, users, clients, systems, and/or platforms to access and/or analyze the requested data. This may conserve processing resources, network resources, and/or computing resources, among other examples, that would have otherwise been associated with the other applications, users, clients, systems, and/or platforms transmitting requests (e.g., client requests) for the requested data and with the orchestration device obtaining the requested data from the external data source in a similar manner as described herein.

Additionally, or alternatively, the one or more actions may include generating and/or storing log information associated with the client request. For example, the client request may be associated with an identifier. The orchestration device may store log information indicating any communications with the external data source, including the external request, in connection with the identifier. For example, the log data may include data associated with events that have occurred in association with an application executing on the orchestration device. For example, a log may identify one or more scripts, queries, operations, jobs, and/or other information designed to provide information regarding the status of data retrieval from the external data source in connection with the client request. As another example, the log data may indicate information used to perform one or more processes and/or one or more applications described herein. As another example, a log may indicate information obtained from another source, such as the external data source. Because the external data sources may communicate with the orchestration device via the integration service layer, the configurations and/or protocols specific to the external data sources may be abstracted from internal operations of the data orchestration system. This reduces the complexity and enables the log data to be stored in a consistent and/or predictable manner. As a result, the log data may be processed and/or analyzed more quickly and/or with a more efficient resource utilization. For example, the orchestration device (and/or another device) may use the identifier of the client request to quickly and easily identify log data for a specific request to an external data source (e.g., by searching the log data using the identifier).

As shown by reference number 150, the orchestration device may store the response (e.g., provided to the client device) in one or more databases. This may enable the orchestration device to access requested data from the one or more databases, such as in response to future client requests that request the same data. This may reduce a quantity of external requests transmitted by the orchestration device, thereby conserving processing resources, computing resources, and/or network resources, that would have been otherwise associated with transmitting multiple requests to one or more external data sources for the same data.

In some implementations, the orchestration device may store the response (e.g., the requested data) in a first database and a second database. For example, the response may be temporarily stored in the first database for an amount of time that is based on a configuration associated with the external data source. For example, the amount of time (or duration) of storage for requested data in the first database may be based on the external data source from which the requested data was obtained. The response (e.g., the requested data) may be archived in the second database. For example, the first database may be a “not only structured query language” (NoSQL) database. The second database may be an object storage database (e.g., a cloud-based object storage database). By the orchestration device using the NoSQL database for the temporary storage of the response, the orchestration device may be enabled to reduce a latency and/or improve a performance of data retrieval for the requested data (e.g., in response to future client requests) because NoSQL databases may be associated with high performance data processing. By the orchestration device using the object storage database, a data storage performance for archived responses may be improved because the object storage database may be associated with high performance for large scale data storage.

As indicated above, FIGS. 1A-1C are provided as an example. Other examples may differ from what is described with regard to FIGS. 1A-1C.

FIG. 2 is a diagram of an example data orchestration system 200 associated with external data source data orchestration. As shown in FIG. 2, the data orchestration system 200 includes a client device, an internal gateway, an orchestration component, a sensitive information (SI) repository, a streaming component, a first database, a second database, an integration service (IS) layer (e.g., that includes one or more integration service components), an external gateway, a network, and one or more external data sources. The components and arrangement of components depicted in FIG. 2 are provided as an example. Other components and/or other arrangements of components may be used to perform one or more operations described herein. In some implementations, the orchestration component and/or one or more other components depicted in FIG. 2 may be, or may be included in, the orchestration device described elsewhere herein, such as in connection with FIGS. 1A-1C.

As shown in FIG. 2, the client device may communicate with the data orchestration system 200 via an internal gateway. A gateway may be a network component that is configured to be an intermediary between different networks or protocols. The internal gateway may enable communication between the client device and the orchestration component. For example, the client device may transmit client requests (e.g., for data stored or accessible via an external data source) via the internal gateway.

The orchestration component may be an orchestrator for the data orchestration system 200. For example, the orchestration component may perform one or more operations, such as operations described in connection with the orchestration device and FIGS. 1A-1C. For example, the orchestration component may obtain a client request. The orchestration component may determine an external data source via which requested data is to be obtained. The orchestration component may identify an integration service component associated with the external data source. The orchestration component may provide information indicated by the client request to the identified integration service component.

The integration service component may be included in an integration service layer. “Layer” may refer to a logical division or abstraction for different components, modules, or functionalities of the data orchestration system 200. For example, the integration service layer may encapsulate functionalities associated with communicating with different external data sources in accordance with protocols, formats, schema, and/or other configurations for the different external data sources.

The integration service layer may include integration service components for respective external data sources that are configured to communicate with the data orchestration system 200. In some implementations, there may be a one-to-one relationship between integration service components and external data sources. For example, the integration service component 1 may be configured to communicate with the data source 1, the integration service component 2 may be configured to communicate with the data source 2, the integration service component 3 may be configured to communicate with the data source 3, and so on. An external data source may be added to (e.g., onboarded and/or configured to communicate with) the data orchestration system 200 by configuring an integration service component for the external data source.

For example, an integration service component may generate a payload for a communication to be transmitted to an external data source via which requested data (e.g., by the client device) is accessible or stored. In some implementations, the integration service component may decrypt tokenized information provided by the orchestration component, such as via the sensitive information repository. For example, the sensitive information repository may be the token vault described elsewhere herein. The integration service component may transmit the communication to the external data source via an external gateway and a network, such as the network described in connection with FIG. 3. The external data source may provide a response to the data orchestration system 200 by transmitting the response via the network and the external gateway to the integration service component. The integration service component may process the response and extract the requested data. In some implementations, the integration service component may encrypt sensitive information that is included in the requested data, such as via the sensitive information repository (e.g., by tokenizing or otherwise encrypting the sensitive information).

The integration service component may provide the requested data to the orchestration component (e.g., after encrypting or tokenizing any sensitive information). The orchestration component may provide, via the internal gateway, the requested data. Additionally, the orchestration component may provide, via the streaming component, the requested data to a data lake, as described in more detail elsewhere herein. The orchestration component may generate and/or store log data for the client request (e.g., documenting one or more actions, scripts, operations, and/or other log data associated with the fulfillment of the client request). Additionally, the orchestration component may store the requested data in the first database and/or the second database. For example, the first database may be the NoSQL database (e.g., for temporary storage of the requested data) and the second database may be the object storage database (e.g., for archiving the requested data) described in more detail elsewhere herein.

As indicated above, FIG. 2 is provided as an example. Other examples may differ from what is described with regard to FIG. 2. The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single device or component, or a single device or component shown in FIG. 2 may be implemented as multiple, distributed devices or components. Additionally, or alternatively, a set of components (e.g., one or more components) shown in FIG. 2 may perform one or more functions described as being performed by another set of components shown in FIG. 2.

FIG. 3 is a diagram of an example environment 300 in which systems and/or methods described herein may be implemented. As shown in FIG. 3, environment 300 may include an orchestration device 310, a client device 320, one or more databases 330, one or more data sources 340, and a network 350. Devices of environment 300 may interconnect via wired connections, wireless connections, or a combination of wired and wireless connections.

The orchestration device 310 may include one or more devices capable of receiving, generating, storing, processing, providing, and/or routing information associated with external data source data orchestration, as described elsewhere herein. The orchestration device 310 may include a communication device and/or a computing device. For example, the orchestration device 310 may include a server, such as an application server, a client server, a web server, a database server, a host server, a proxy server, a virtual server (e.g., executing on computing hardware), or a server in a cloud computing system. In some implementations, the orchestration device 310 may include computing hardware used in a cloud computing environment.

The client device 320 may include one or more devices capable of receiving, generating, storing, processing, and/or providing information associated with external data source data orchestration, as described elsewhere herein. The client device 320 may include a communication device and/or a computing device. For example, the client device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

A database 330 may include one or more devices capable of receiving, generating, storing, processing, and/or providing information associated with external data source data orchestration, as described elsewhere herein. The database 330 may include a communication device and/or a computing device. For example, the database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the database 330 may store data obtained via one or more external data sources, such as a data source 340, as described elsewhere herein.

The data source 340 may include one or more devices capable of receiving, generating, storing, processing, and/or providing information associated with external data source data orchestration, as described elsewhere herein. The data source 340 may include a communication device and/or a computing device. For example, the data source 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 340 may communicate with one or more other devices of environment 300, as described elsewhere herein.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with external data source data orchestration. The device 400 may correspond to the orchestration device 310, the client device 320, a database 330, and/or a data source 340. In some implementations, the orchestration device 310, the client device 320, a database 330, and/or a data source 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

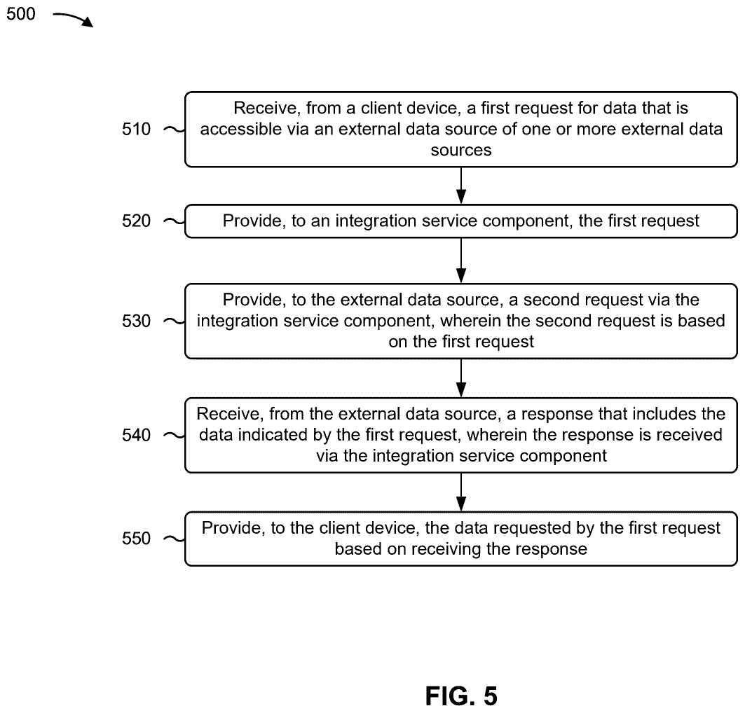

FIG. 5 is a flowchart of an example process 500 associated with external data source data orchestration. In some implementations, one or more process blocks of FIG. 5 may be performed by the orchestration device 310. In some implementations, one or more process blocks of FIG. 5 may be performed by another device or a group of devices separate from or including the orchestration device 310, such as the data orchestration system 200, the client device 320, one or more databases 330, and/or one or more external data sources 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a client device, a first request for data that is accessible via an external data source of one or more external data sources (block 510). For example, the orchestration device 310 (e.g., using processor 420, memory 430, input component 440, and/or communication component 460) may receive, from a client device, a first request for data that is accessible via an external data source of one or more external data sources, as described above in connection with reference number 105 of FIG. 1A. In some implementations, the orchestration device 310 includes one or more integration service components associated with respective external data sources of the one or more external data sources. As an example, the first request may be a client request as described elsewhere herein.

As further shown in FIG. 5, process 500 may include providing, to an integration service component of the one or more integration service components, the first request (block 520). For example, the orchestration device 310 (e.g., using processor 420 and/or memory 430) may provide, to an integration service component of the one or more integration service components, the first request, as described above in connection with reference number 120 of FIG. 1B. As an example, the orchestration device 310 may provide the request to the integration service component that is associated with the external data source via which the data indicated by the first request is stored or is otherwise accessible.

As further shown in FIG. 5, process 500 may include providing, to the external data source, a second request via the integration service component (block 530). For example, the orchestration device 310 (e.g., using processor 420 and/or memory 430) may provide, to the external data source, a second request via the integration service component, as described above in connection with reference number 130 of FIG. 1B. In some implementations, the second request is based on the first request. As an example, the second request may be an external request, as described in more detail elsewhere herein. The integration service component may generate or determine a payload of the second request using information indicated by the first request. The second request may follow a format, syntax, and/or protocol, among other examples, that is associated with communicating with the external data source.

As further shown in FIG. 5, process 500 may include receiving, from the external data source, a response that includes the data indicated by the first request (block 540). For example, the orchestration device 310 (e.g., using processor 420, memory 430, input component 440, and/or communication component 460) may receive, from the external data source, a response that includes the data indicated by the first request, as described above in connection with reference number 135 of FIG. 1B. In some implementations, the response is received via the integration service component. As an example, the orchestration device 310 may receive the response via an integration service layer that includes the integration service component.

As further shown in FIG. 5, process 500 may include providing, to the client device, the data requested by the first request based on receiving the response (block 550). For example, the orchestration device 310 (e.g., using processor 420 and/or memory 430) may provide, to the client device, the data requested by the first request based on receiving the response, as described above in connection with reference number 145 of FIG. 1C. As an example, the orchestration device 310 may provide the data requested via the first request to the client device via an internal gateway and based on obtaining the requested data via the integration service component.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for external data source data orchestration, the system comprising:
a gateway;
an integration service layer including one or more integration service components for respective external data sources of one or more external data sources; and
an orchestration component configured to:
receive, via a client device, a first request for data that is accessible via an external data source of the one or more external data sources;
provide, to an integration service component of the one or more integration service components, the first request,
wherein the integration service component is configured to generate requests for data from the external data source;
generate, based on providing the first request to the integration service component, a second request via the integration service component;
provide, by the integration service component and via the gateway, the second request to the external data source;
receive, by the integration service component and via the gateway, a response from the external data source that includes the data indicated by the first request; and
provide, to the client device, the data requested by the first request based on receiving the response.

2. The system of claim 1, wherein the one or more integration service components are configured to generate communications using protocols for the respective external data sources of the one or more external data sources.

3. The system of claim 1, wherein the one or more integration service components are configured to:
obtain configuration information to enable the one or more integration service components to exchange information with the respective external data sources of the one or more external data sources.

4. The system of claim 1, wherein the first request includes tokenized information,
wherein the integration service component is configured to decrypt the tokenized information to obtain request information, and
wherein the second request includes the request information.

5. The system of claim 1, wherein the response includes sensitive information,
wherein the integration service component is configured to encrypt the sensitive information to generate tokenized information to obfuscate the sensitive information, and
wherein the data includes in the tokenized information.

6. The system of claim 1, wherein the orchestration component is further configured to:
provide, via a streaming platform, the data to a data lake based on receiving the response.

7. The system of claim 1, wherein the data is accessible via multiple external data sources including the external data source, and wherein the orchestration component is further configured to:
determine that the data is to be retrieved via the external data source based on performance parameters associated with the respective external data sources of the multiple external data sources.

8. The system of claim 1, wherein the orchestration component is further configured to:
store the data in a first database and a second database,
wherein the data is temporarily stored in the first database for an amount of time that is based on a configuration associated with the external data source, and
wherein the data is archived in the second database.

9. The system of claim 8, wherein the first database is a not only structured query language (NoSQL) database, and
wherein the second database is an object storage database.

10. The system of claim 1, wherein the first request is associated with an identifier, and wherein the orchestration component is further configured to:
store log information indicating any communications with the external data source, including the second request, in connection with the identifier.

11. A method for external data source data orchestration comprising:
receiving, by a device and from a client device, a first request for data that is accessible via an external data source of one or more external data sources,
wherein the device includes one or more integration service components associated with respective external data sources of the one or more external data sources;
providing, by the device and to an integration service component of the one or more integration service components, the first request;
providing, by the device and to the external data source, a second request via the integration service component,
wherein the second request is based on the first request;
receiving, by the device and from the external data source, a response that includes the data indicated by the first request,
wherein the response is received via the integration service component; and
providing, by the device and to the client device, the data requested by the first request based on receiving the response.

12. The method of claim 11, further comprising:
generating, via the integration service component, a payload of the second request using the first request and a protocol configuration associated with the external data source,
wherein the integration service component stores the protocol configuration.

13. The method of claim 11, wherein the one or more integration service components are configured to generate communications using protocols for the respective external data sources of the one or more external data sources.

14. The method of claim 11, wherein the first request includes encrypted information, wherein the method further comprises:
decrypting, via the integration service component, the encrypted information to obtain request information,
wherein the second request includes the request information.

15. The method of claim 11, wherein the data is accessible via multiple external data sources including the external data source, and the method further comprising:
determining that the data is to be retrieved via the external data source based on performance parameters associated with the respective external data sources of the multiple external data sources.

16. The method of claim 11, further comprising:
storing the data in a first database and a second database,
wherein the data is temporarily stored in the first database for an amount of time that is based on a configuration associated with the external data source, and
wherein the data is archived in the second database.

17. A non-transitory computer-readable medium storing a set of instructions, the set of instructions comprising:
one or more instructions that, when executed by one or more processors of a device, cause the device to:
receive, from a client device, a first request for data that is accessible via an external data source of one or more external data sources,
wherein the device includes one or more integration service components associated with respective external data sources of the one or more external data sources;
provide, to an integration service component of the one or more integration service components, the first request;
provide, to the external data source, a second request via the integration service component,
wherein the second request is based on the first request;
receive, from the external data source, a response that includes the data indicated by the first request,
wherein the response is received via the integration service component; and
provide, to the client device, the data requested by the first request based on receiving the response.

18. The non-transitory computer-readable medium of claim 17, wherein the one or more instructions further cause the device to:
generate, via the integration service component, a payload of the second request using the first request and a protocol configuration associated with the external data source.

19. The non-transitory computer-readable medium of claim 17, wherein the response includes sensitive information, wherein the one or more instructions further cause the device to:
encrypt, via the integration service component, the sensitive information to obtain encrypted information,
wherein the data provided to the client device includes the encrypted information.

20. The non-transitory computer-readable medium of claim 17, wherein the one or more instructions further cause the device to:
store the data in a first database and a second database.
